(19) United States
(12) Patent Application Publication
(10) Pub. No.: US 2019/0268668 A1
(43) Pub. Date: Aug. 29, 2019

(54) REAL-TIME STREAMING OF REACTION FEEDBACK

(71) Applicant: GoPro, Inc., San Mateo, CA (US)

(72) Inventors: Stepan Moskovchenko, Belmont, CA (US); Benjamin P. Tankersley, San Mateo, CA (US); Joseph A. Enke, Campbell, CA (US)

(21) Appl. No.: 16/288,409

(22) Filed: Feb. 28, 2019

Related U.S. Application Data
(60) Provisional application No. 62/636,487, filed on Feb. 28, 2018.

(51) Int. Cl. H04N 21/488; H04N 21/2187; H04N 21/258; H04N 21/4788; H04N 21/475

(52) U.S. Cl. CPC H04N 21/4882; H04N 21/2187; H04N 21/4756; H04N 21/4788; H04N 21/25866

(57) ABSTRACT

An image capture device is used to capture an event. A user of the image capture device may stream the captured event using one or more social media platforms. Viewers of the streamed event may provide feedback to the user of the image capture device while viewing the streamed event. An example method for providing the feedback to the user of the image capture device includes receiving feedback information items from viewers viewing the streamed event. The method may include assigning a score to each feedback information item and generating a feedback indication based on the scores assigned to each of the feedback information items. The method may include providing the feedback indication to the user of the image capture device using a feedback indicator associated with the image capture device.

### CROSS-REFERENCE TO RELATED APPLICATION(S)

This application claims priority to and the benefit of U.S. Provisional Application Patent Ser. No. 62/636,487, filed Feb. 28, 2018, the entire disclosure of which is incorporated by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present disclosure relates to methods and systems for real-time streaming of reaction feedback.

### SUMMARY

This disclosure relates generally to real-time streaming of reaction feedback. An aspect of the disclosed embodiments is a method for a feedback indication during a live stream of an event. The method includes receiving feedback information items from viewers viewing the live stream of the event. The method includes assigning a score to each feedback information item. The method includes generating a first feedback indication based on the scores assigned to each respective feedback information item. The method includes providing the first feedback indication to a user of the device capturing the event using a feedback indicator of the device capturing the event.

Another aspect of the disclosed embodiments is an image capture device including an image sensor configured to capture visual information. The image capture device includes a communication unit configured to stream the visual information to a server hosting a social media platform and receive feedback information items related to the visual information from the social media platform. The image capture device includes a processor configured to apply a score to each of the feedback information items and generate a feedback indication based on the score associated with each of the feedback information items. The image capture device includes a user interface configured to output the feedback indication to a user of the image capture device.

Another aspect of the disclosed embodiments is a real-time streaming reaction feedback system. The real-time streaming reaction feedback system includes an image capture device having an image sensor configured to capture visual information. The image capture device includes a communication unit configured to communicate the visual information. The real-time streaming reaction feedback system includes a secondary device. The secondary device includes a communication unit configured to receive the visual information, stream the visual information to a server hosting a social media platform, and receive feedback information items related to the visual information from the social media platform. The secondary device includes a processor configured to apply a score to each of the feedback information items and generate a feedback indication based on the score associated with each of the feedback information items. The secondary device includes a user interface configured to output the feedback indication to a user of the image capture device.

### BACKGROUND

Image capture devices, such as cameras, may capture content such as media data including image data, video data, and audio data. Increasingly, users of such capture devices are capturing events and live streaming the events to viewers using various social media platforms. Viewers of live streams typically provide feedback to the user live streaming the event during the live streaming of the event. The feedback may include likes, dislikes, images (e.g., emoji or other images), comments, other suitable feedback, and/or a combination thereof. The feedback may be presented to the user live streaming the event via a plurality of feedback information items temporality displayed to the user.

### BRIEF DESCRIPTION OF THE DRAWINGS

The disclosed embodiments have other advantages and features which will be more readily apparent from the detailed description, the appended claims, and the accompanying figures. A brief introduction of the figures is below.

FIG. 1A generally illustrates an example of an image capture system according to the principles of the present disclosure.

FIG. 1B generally illustrates an example of an image capture system according to the principles of the present disclosure.

FIG. 2 generally illustrates an example set of components of an image capture device according to the principles of the present disclosure.

FIG. 3 generally illustrates an example real-time streaming reaction feedback system according to the principles of the present disclosure.

FIG. 4 generally illustrates an example image capture device according to the principles of the present disclosure.

FIG. 5 generally illustrates an example image capture device according to the principles of the present disclosure.

FIG. 6 generally illustrates an example image capture device according to the principles of the present disclosure.

FIG. 7 is a flow chart generally illustrating an example set of operations of a method for providing real-time streaming reaction feedback according to the principles of the present disclosure.

All figures disclosed herein are © Copyright 2019 GoPro Inc. All rights reserved.

### DETAILED DESCRIPTION

Implementations of the present technology will now be described in detail with reference to the drawings, which are provided as examples so as to enable those skilled in the art to practice the technology. The figures and examples are not meant to limit the scope of the present disclosure to a single implementation or embodiment, and other implementations and embodiments are possible by way of interchange of, or combination with, some or all of the described or illustrated elements.

As image capture devices are becoming more versatile, users of these image capture devices are using image capture devices to stream events captured by the image capture devices. Image capture devices may include handheld digital cameras, body cameras or other wearable cameras, drone cameras, or other suitable image capture devices. The user of the image capture device may stream the event captured by the image capture device to viewers using various social media platforms. For example, a user of the image capture device may use the image capture device to live stream the user skiing down a ski slope on a first social media platform. Members of the first social media platform may view the live stream of the event captured by the image capture device.

Typically, viewers of the live stream of an event provide feedback to the user streaming the event using an interface associated with the social media platform the viewers use to view the streamed event. For example, a viewer of a first streamed event may view the first streamed event on the first social media platform. The first social media platform may include a first interface. The first interface may include one or more reaction or feedback mechanisms. The reaction or feedback mechanisms may include a “thumbs up” button, a “thumbs down” button, a happy face, a sad face, a heart, a freeform comment box, other suitable reaction or feedback mechanisms, and/or a combination thereof. A viewer using the first social media platform to view the streamed event may utilize the reaction or feedback mechanisms to provide feedback to the user streaming the streamed event. For example, a viewer may select a “thumbs up” reaction mechanism to indicate that the viewer is enjoying the content of the streamed event.

The user streaming the streamed event may receive feedback information items from a plurality of viewers viewing the streamed event. The user streaming the streamed event may receive a plurality of feedback information items on a user interface associated with the social media platform the streamed event is being streamed on. For example, the user interface may display a feedback information item for each reaction or feedback mechanism selected by each of the plurality of viewers viewing the streamed event. In some implementations, the feedback information items may include aesthetic features similar to the aesthetic features of the reaction or feedback mechanisms.

During a streamed event, the user streaming the streamed event may receive, via the user interface of the social media platform the streamed event is streamed on, dozens, hundreds, thousands, or more feedback information items. The feedback information items may scroll across the interface such that the user may only temporarily see any one particular feedback information item. Further, if the user's attention is not on the user interface of the social media platform, the user may not see many of the feedback information items.

In some implementations, the user streaming the streamed event may stream the event on multiple social media platforms. For example, the user may live stream the user skiing down the ski slope on the first social media platform and a second social media platform simultaneously. Accordingly, the user may receive a plurality of feedback information items from viewers of the streamed event on the first social media platform via the user interface associated with the first social media platform and a plurality of feedback information items from viewers of the streamed event of the second social media platform via a user interface associated with the second social media platform. This may make it difficult for the user streaming the event to view the feedback information items. Accordingly, a system and method that provide, to the user streaming the event, feedback indications that represent summaries of the feedback information items associated with one or more social media platforms may be desirable.

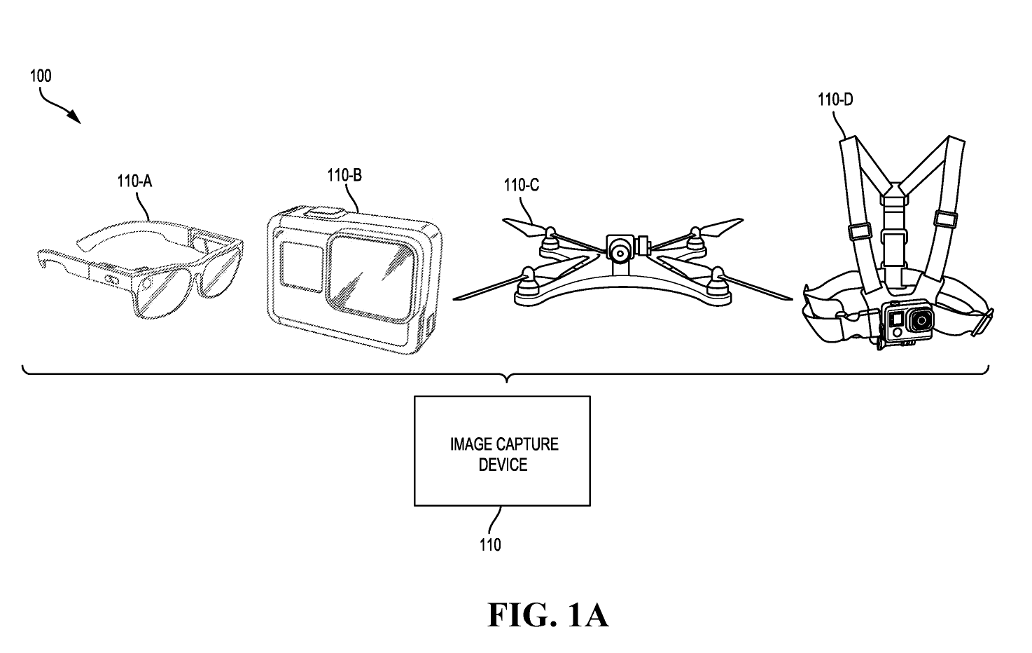

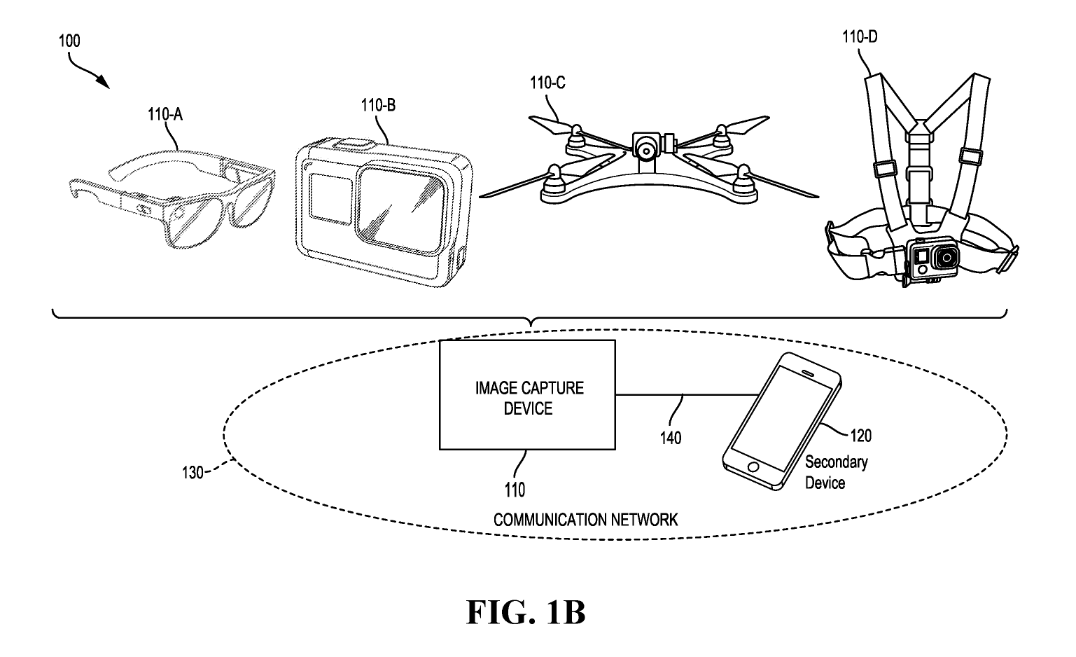

FIG. 1A illustrates an example of an image capture system 100 configured to capture media data in accordance with some implementations of this disclosure. As shown in FIG. 1A, an image capture system 100 includes an image capture device 110. The image capture device 110 may be any form factor device. The image capture device 110 may be implemented in the form of a glasses/sunglasses video camera 110-A, a handheld/mountable camera 110-B, a drone system camera 110-C, a wearable camera 110-D, or any other suitable format (e.g., a spherical camera, a mobile device camera, or a traditional video camera). The form factors depicted in FIG. 1A are provided for example only, and the image capture system 100 may be implemented in any other suitable form factor. In the implementations of FIG. 1A, the image capture device 110 may include persistent storage and a user interface with which the user may interact. The user interface may be physical, graphical, or speech-based.

In some implementations, the image capture device 110 may include a body having a lens structured on a front surface of the body. The image capture device 110 may include an exterior that encompasses and protects internal electronics. In one example, the exterior may include six surfaces (i.e. a front face, a left face, a right face, a back face, a top face, and a bottom face) that form a rectangular cuboid. Both the front and rear surfaces may be rectangular. In other implementations, the exterior may have a different shape. The body of the image capture device 110 may be made of a rigid material such as plastic, aluminum, steel, or fiberglass.

FIG. 1B illustrates an example of an image capture system 100 configured to capture media data in accordance with some implementations of this disclosure. In the image capture system 100 of FIG. 1B, the image capture device 110 communicates with a secondary device 120 via a communication network 130. The secondary device 120 may be any suitable computing device, including but not limited to a smartphone, a tablet computer, a phablet, a smartwatch, a portable computer, other suitable device, and/or combination thereof. In the implementations of FIG. 1B, the image capture device 110 may not have the requisite resources to store media data or may not have the requisite resources to interface with the user (e.g., no display to present a graphical user interface). Thus, by communicating with the image capture device 110, the secondary device 120 may allow the image capture device 110 to access the permanent storage residing on the secondary device 120 via the communication network 130 and to write media data thereto.

In some implementations, the secondary device 120 may provide a user interface that allows the user to control the image capture device 110 via the communication network 130. For example, the secondary device 120 may present a graphical user interface via a touch screen of the secondary device 120. In some implementations, the user may input commands to the secondary device 120, which in turn transmits the commands to the image capture device 110. Similarly, the image capture device 110 may transmit data to the secondary device 120, which the secondary device 120 may display to the user via its user interface. In some implementations, the image capture device 110 includes the requisite resources to store media data and/or may have the requisite resources to interface with the user (e.g., display to present a graphical user interface). Accordingly, the image capture device 110 may not communicate with the secondary device 120.

The communication network 130 may refer to any electronic communication network that facilitates wired or wireless communication between the image capture system 100 and the secondary device 120 via a communication link 140. The communication network 130 may be a local area network (LAN), a wireless local area network (WLAN), or a personal area network (PAN). In some implementations, the communication network 130 may include a wireless link 140, such as a Wi-Fi link, an infrared link, a Bluetooth (BT) link, a cellular link, a ZigBee link, a near field communications (NFC) link, such as an ISO/IEC 23243 protocol link, an Advanced Network Technology interoperability (ANT+) link, and/or any other wireless communications link or combination of links. In some implementations, the communication network 130 may include a wired link 140, such as an HDMI link, a USB link, a digital video interface link, a display port interface link, such as a Video Electronics Standards Association (VESA) digital display interface link, an Ethernet link, a Thunderbolt link, and/or other wired computing communication link 140.

Although not expressly shown in FIGS. 1A and 1B, in some implementations, the image capture device 110 may include one or more image sensors, such as a charge-coupled device (CCD) sensor, an active pixel sensor (APS), a complementary metal-oxide semiconductor (CMOS) sensor, an N-type metal-oxide-semiconductor (NMOS) sensor, and/or any other image sensor or combination of image sensors. Although not expressly shown in FIGS. 1A and 1B, in some implementations, an image capture device 110 may include one or more microphones, which may receive, capture, and record audio information, which may be associated with images acquired by the image sensors. Although not expressly shown in FIGS. 1A and 1B, the image capture system 100 may include one or more other information sources or sensors, such as an inertial measurement unit (IMU), a global positioning system (GPS) receiver component, a pressure sensor, a temperature sensor, a heart rate sensor, or any other unit, or combination of units, that may be included in an image capture apparatus.

In some implementations, the secondary device 120 and/or the image capture device 110 may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 110.

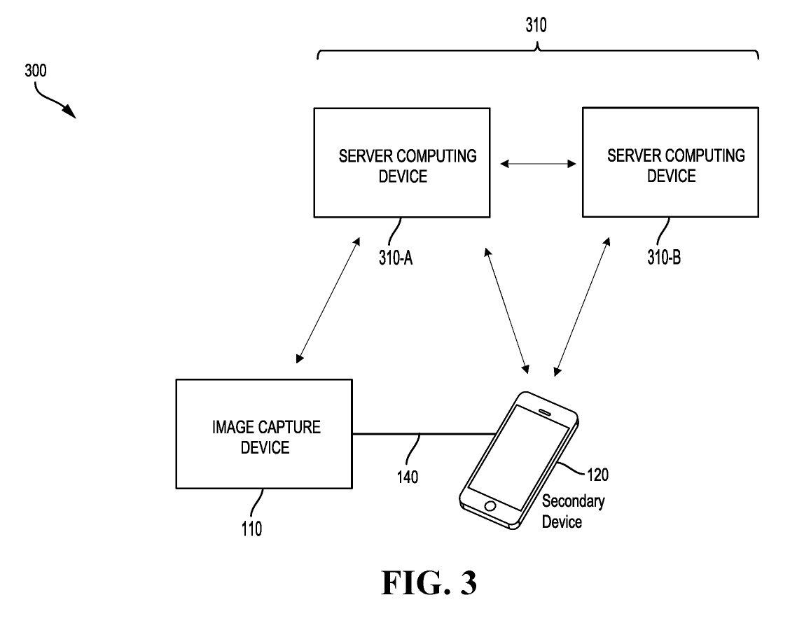

In some implementations, the secondary device 120 and/or the image capture device 110 may communicate with various social media platforms. For example, the secondary device 120 and/or the image capture device 110 may communicate via a network, such as the communication network 130, with a remotely located server computing device (server) that hosts a social media platform, such as a server 310 as is generally illustrated in FIG. 3. The secondary device 120 and/or the image capture device 110 may include and/or provide an application interface, such as a user interface, associated with the social media platform to the user. The user of the image capture device 110 may access the user interface in order to interact with the social media platform.

The secondary device 120 and/or the image capture device 110 may communicate the user's interactions with the user interface to the server 310 executing the social media platform. For example, the user may use the user interface to stream an event captured by the image capture device 110 to the social media platform. As described, the user interface may display feedback information items received from viewers of the streamed event. In some implementations, as described, the user may stream the streamed event to more than one social media platform simultaneously. Accordingly, the secondary device 120 and/or the image capture device 110 may communicate with more than one server 310 corresponding to each of the more than one social media platforms. For example, the secondary device 120 and/or the image capture device 110 may communicate with a first server 310-A that executes or hosts a first social media platform and a second server 310-B that executes or hosts a second social media platform. The secondary device 120 and/or the image capture device 110 may receive feedback information items from each of the first social media platform and the second social media platform from the first server 310-A and the second server 310-B, respectively, as described above.

It is noted that the image capture systems 100 of FIGS. 1A and 1B are provided for example only. The techniques described herein may be applied in any image capture system 100 that is configured to record media data.

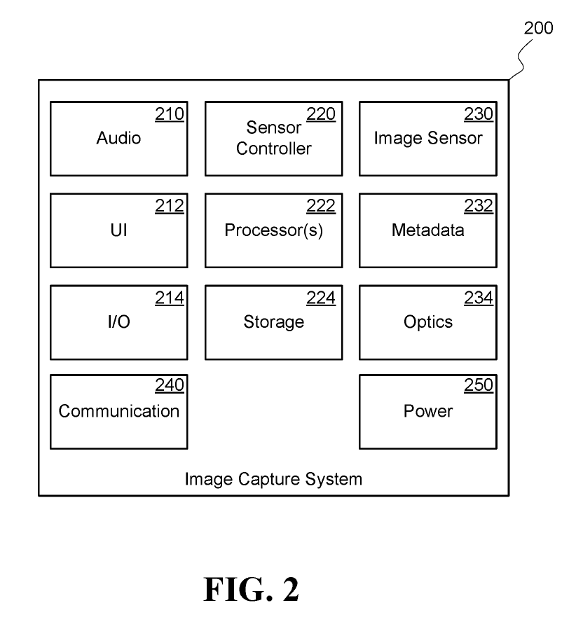

FIG. 2 is a block diagram of an example image capture system 200 in accordance with some implementations of this disclosure. In some implementations, the image capture system 200 is the image capture system 100 of FIG. 1A or 1B. The image capture system 200 may include an audio component 210, a user interface (UI) unit 212, an input/output (I/O) unit 214, a sensor controller 220, one or more processors 222, an electronic storage unit 224, an image sensor 230, a metadata unit 232, an optics unit 234, a communication unit 240, a power system 250, and/or a combination thereof. The components of the image capture system 200 may be incorporated wholly on an image capture device or distributed across an image capture device and one or more secondary devices.

In some implementations, the audio component 210, which may include one or more microphones, may receive, sample, capture, record, and/or a combination thereof audio data, such as sound waves, which may be associated with, such as stored in association with, image or video content contemporaneously captured by the image capture system 200. In some implementations, audio data may be encoded using, e.g., Advanced Audio Coding (AAC), Audio Compression-3 (AC3), Moving Picture Experts Group Layer-3 Audio (MP3), linear Pulse Code Modulation (PCM), Motion Picture Experts Group-High efficiency coding and media delivery in heterogeneous environments (MPEG-H), and/or other audio coding formats (audio codecs).

In some implementations, the UI 212 may include one or more units that may register or receive input from and/or present outputs to a user, such as a display (e.g. LCD display), a touch interface, a proximity sensitive interface, a light receiving/emitting unit, a sound receiving/emitting unit, a wired/wireless unit, and/or other units. In some implementations, the UI 212 may include a display screen, one or more tactile elements (e.g., buttons and/or virtual touch screen buttons), lights (LEDs), speakers, and/or other user interface elements. The UI 212 may receive user input and/or provide information to a user related to the operation of the image capture system 200.

In some implementations, the UI 212 may include a display unit that presents information related to camera control or use, such as operation mode information (e.g., image resolution, frame rate, capture mode, sensor mode, video mode, photo mode), connection status information (e.g., connected, wireless, wired connection), power mode information (e.g., standby mode, sensor mode, video mode), information related to other information sources (e.g., heart rate, GPS), and/or other information.

In some implementations, the UI 212 may include a user interface component such as one or more buttons, which may be operated, such as by a user, to control camera operations, such as to start, stop, pause, and/or resume sensor and/or content capture. The camera control associated with respective user interface operations may be defined. For example, the camera control associated with respective user interface operations may be defined based on the duration of a button press (pulse width modulation), a number of button presses (pulse code modulation), and/or a combination thereof. In an example, a sensor acquisition mode may be initiated in response to detecting two short button presses. In another example, the initiation of a video mode and cessation of a photo mode, or the initiation of a photo mode and cessation of a video mode, may be triggered (toggled) in response to a single short button press. In another example, video or photo capture for a given time duration or a number of frames (burst capture) may be triggered in response to a single short button press. Other user commands, or communication implementations, may be implemented, such as one or more short or long button presses.

In some implementations, the UI 212 may include a user interface associated with one or more social media platforms, as described above. In some implementations, the UI 212 may include one or more feedback indicators, as will be described. For example, the UI 212 may include one or more light emitting diodes, one or more haptic mechanisms, one or more displays, other suitable feedback indicators, and/or a combination thereof.

In some implementations, the I/O unit 214 may synchronize the image capture device 110 with other cameras and/or with other external devices, such as a remote control, a second image capture device, a smartphone, a user interface device, such as the secondary device 120 shown in FIG. 1, and/or a video server. The I/O unit 214 may communicate information between I/O components. In some implementations, the I/O unit 214 may be connected to the communication unit 240 to provide a wired and/or wireless communications interface (e.g., Wi-Fi, Bluetooth, USB, HDMI, Wireless USB, Near Field Communication (NFC), Ethernet, a radio frequency transceiver, and/or other interfaces) for communication with one or more external devices, such as a user interface device, such as the secondary device 120 shown in FIG. 1B, to a remotely located server executing one or more social media platforms, and/or other suitable metadata source. In some implementations, the I/O unit 214 may interface with LED lights, a display, a button, a microphone, speakers, and/or other I/O components. In some implementations, the I/O unit 214 may interface with an energy source, e.g., a battery, and/or a Direct Current (DC) electrical source.

In some implementations, the I/O unit 214 of the image capture system 200 may include one or more connections to external computerized devices for configuration and/or management of remote devices, as described herein. The I/O unit 214 may include any of the wireless or wireline interfaces described herein, and/or may include customized or proprietary connections for specific applications.

In some implementations, the sensor controller 220 may operate or control the image sensor 230, such as in response to input, such as user input. In some implementations, the sensor controller 220 may receive image and/or video input from the image sensor 230 and may receive audio information from the audio component 210.

In some implementations, the processor(s) 222 may include a system on a chip (SOC), microcontroller, microprocessor, CPU, DSP, application-specific integrated circuit (ASIC), GPU, and/or other processor that may control the operation and functionality of the image capture device 110. In some implementations, the processor(s) 222 may interface with the sensor controller 220 to obtain and process sensory information for, e.g., filtering, tone mapping, stitching, encoding, object detection, face tracking, stereo vision, and/or other image processing.

In some implementations, the sensor controller 220, the processor(s) 222, or both may synchronize information received by the image capture system 200. For example, timing information may be associated with received sensor data, and metadata information may be related to content (photo/video) captured by the image sensor 230 based on the timing information. In some implementations, the metadata captured may be decoupled from video/image capture. For example, metadata may be stored before, after, and in-between the capture, processing, or storage of one or more video clips and/or images.

In some implementations, the sensor controller 220, the processor(s) 222, or both may evaluate or process received metadata and may generate other metadata information. For example, the sensor controller 220 may integrate the received acceleration information to determine a velocity profile for the image capture system 200 concurrent with recording a video. In some implementations, video information may include multiple frames of pixels and may be encoded using an encoding method (e.g., H.265, H.264, CineForm, and/or other codec).

Although not shown separately in FIG. 2, one or more of the audio component 210, the UI 212, the I/O unit 214, the sensor controller 220, the processor 222, the electronic storage unit 224, the image sensor 230, the metadata unit 232, the optics unit 234, the communication unit 240, or the power systems 250 of the image capture system 200 may communicate information, power, or both with one or more other units, such as via an electronic communication pathway, such as a system bus. For example, the processor 222 may interface with the audio component 210, the UI 212, the I/O unit 214, the sensor controller 220, the electronic storage unit 224, the image sensor 230, the metadata unit 232, the optics unit 234, the communication unit 240, or the power systems 250 via one or more driver interfaces and/or software abstraction layers. In some implementations, one or more of the units shown in FIG. 2 may include a dedicated processing unit, memory unit, or both (not shown). In some implementations, one or more components may be operable by one or more other control processes. For example, a GPS receiver may include a processing apparatus that may provide position and/or motion information to the processor 222 in accordance with a defined schedule (e.g., values of latitude, longitude, and elevation at 10 Hz).

In some implementations, the electronic storage unit 224 may include a system memory module that may store executable computer instructions that, when executed by the processor 222, perform various functionalities including those described herein. For example, the electronic storage unit 224 may be a non-transitory computer-readable storage medium, which may include executable instructions, and a processor, such as the processor 222, may execute the instructions to perform one or more, or portions of one or more, of the operations described herein. The electronic storage unit 224 may include storage memory for storing content (e.g., metadata, images, audio) captured by the image capture system 200. As used herein, the term “memory” includes any type of integrated circuit or other storage device adapted for storing digital data, including, without limitation, read-only memory (ROM), programmable ROM (PROM), electrically erasable PROM (EEPROM), dynamic random access memory (DRAM), Mobile DRAM, synchronous DRAM (SDRAM), Double Data Rate 2 (DDR/2) SDRAM, extended data out (EDO)/fast page mode (FPM), reduced latency DRAM (RLDRAM), static RAM (SRAM), “flash” memory, such as NAND/NOR, memristor memory, and pseudo SRAM (PSRAM).

In some implementations, the electronic storage unit 224 may include non-transitory memory for storing configuration information and/or processing code for video information and metadata capture, and/or to produce a multimedia stream that may include video information and metadata in accordance with the present disclosure. In some implementations, the configuration information may include capture type (video, still images), image resolution, frame rate, burst setting, white balance, recording configuration (e.g., loop mode), audio track configuration, and/or other parameters that may be associated with audio, video, and/or metadata capture. In some implementations, the electronic storage unit 224 may include memory that may be used by other hardware/firmware/software elements of the image capture system 200.

In some implementations, the image sensor 230 may include one or more of a charge-coupled device sensor, an active pixel sensor, a complementary metal-oxide semiconductor sensor, an N-type metal-oxide-semiconductor sensor, and/or other suitable image sensor or combination of image sensors. In some implementations, the image sensor 230 may be controlled based on control signals from a sensor controller 220.

The image sensor 230 may be configured to capture visual information. The image sensor 230 may sense or sample light waves gathered by the optics unit 234 and may produce image data or signals. The image sensor 230 may generate an output signal conveying the visual information regarding the objects or other content corresponding to the light waves received by the optics unit 234. The visual information may include one or more of an image, a video, and/or other visual information.

In some implementations, the image sensor 230 may include a video sensor, an acoustic sensor, a capacitive sensor, a radio sensor, a vibrational sensor, an ultrasonic sensor, an infrared sensor, a radar sensor, a Light Detection And Ranging (LIDAR) sensor, a sonar sensor, or any other sensory unit or combination of sensory units capable of detecting or determining information in a computing environment.

In some implementations, the metadata unit 232 may include metadata sensors such as an IMU, which may include one or more accelerometers and/or gyroscopes, a magnetometer, a compass, a GPS sensor, an altimeter, an ambient light sensor, a temperature sensor, biometric sensor (e.g., a heartrate monitor) and/or other sensors or combinations of sensors. In some implementations, the image capture system 200 may contain one or more other metadata/telemetry sources, e.g., image sensor parameters, battery monitor, storage parameters, and/or other information related to camera operation and/or capture of content. The metadata unit 232 may obtain information related to the environment of the image capture system 200 and aspects in which the content is captured.

For example, the metadata unit 232 may include an accelerometer that may provide device motion information including velocity and/or acceleration vectors representative of motion of the image capture system 200. In another example, the metadata unit 232 may include a gyroscope that may provide orientation information describing the orientation of the image capture system 200. In another example, the metadata unit 232 may include a GPS sensor that may provide GPS coordinates, time, and information identifying a location of the image capture system 200. In another example, the metadata unit 232 may include an altimeter that may obtain information indicating an altitude of the image capture system 200.

In some implementations, the metadata unit 232, or one or more portions thereof, may be rigidly coupled to the image capture device 110 or a secondary device (e.g. the secondary device 120), such that motion, changes in orientation, or changes in the location of the image capture system 200 may be accurately detected by the metadata unit 232. Although shown as a single unit, the metadata unit 232, or one or more portions thereof, may be implemented as multiple distinct units. For example, the metadata unit 232 may include a temperature sensor as a first physical unit and a GPS unit as a second physical unit. In some implementations, the metadata unit 232, or one or more portions thereof, may be included in an image capture device, or may be included in a physically separate unit such as a secondary device (e.g. the secondary device 120).

In some implementations, the optics unit 234 may include one or more of a lens, macro lens, zoom lens, special-purpose lens, telephoto lens, prime lens, achromatic lens, apochromatic lens, process lens, wide-angle lens, ultra-wide-angle lens, fisheye lens, infrared lens, ultraviolet lens, perspective control lens, other lens, and/or other optics component. In some implementations, the optics unit 234 may include a focus controller unit that may control the operation and configuration of the camera lens. The optics unit 234 may receive light from an object and may focus received light onto an image sensor 230. Although not shown separately in FIG. 2, in some implementations, the optics unit 234 and the image sensor 230 may be combined, such as in a combined physical unit, such as a housing.

The communication unit 240 may be configured to transmit and/or receive information (e.g. the visual information captured by the image capture device 110) to and/or from any network, server, secondary device, external device, or any other image capture device. For example, the communication unit 240 may be configured to stream the visual information captured by the image capture device 110 to a server hosting one or more social media platforms and to receive feedback information items from the one or more social media platforms. In some implementations, the communication unit 240 may be coupled to the I/O unit 214 and may include a component (e.g., a dongle) having an infrared sensor, a radio frequency transceiver and antenna, an ultrasonic transducer, and/or other communications interfaces used to send and receive wireless communication signals. In some implementations, the communication unit 240 may include a local (e.g., Bluetooth, Wi-Fi) and/or broad range (e.g., cellular LTE) communications interface for communication between the image capture system 200 and a remote device (e.g., the secondary device 120 in FIG. 1B or the server 310 in FIG. 3). The communication unit 240 may communicate using, for example, Ethernet, 802.11, worldwide interoperability for microwave access (WiMAX), 3G, Long Term Evolution (LTE), digital subscriber line (DSL), asynchronous transfer mode (ATM), InfiniBand, PCI Express Advanced Switching, and/or other communication technologies. In some implementations, the communication unit 240 may communicate using networking protocols, such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or other networking protocols.

Information exchanged via the communication unit 240 may be represented using formats including one or more of hypertext markup language (HTML), extensible markup language (XML), and/or other formats. One or more exchanges of information between the image capture system 200 and remote or external devices may be encrypted using encryption technologies including one or more of secure sockets layer (SSL), transport layer security (TLS), virtual private networks (VPNs), Internet Protocol security (IPsec), and/or other encryption technologies.

In some implementations, the one or more power systems 250 supply power to the image capture device 110. For example, for a small-sized, lower-power action camera a wireless power solution (e.g., battery, solar cell, inductive (contactless) power source, rectification, and/or other power supply) may be used.

Consistent with the present disclosure, the components of the image capture system 200 may be remote from one another and/or aggregated. For example, one or more sensor components may be distal from the image capture device 110, e.g., such as shown and described with respect to FIG. 1B.

FIG. 3 illustrates an example real-time streaming reaction feedback system 300 according to the principles of the present disclosure. The system 300 is configured to transform raw data (e.g., feedback information items, as will be described) received from viewers of a streamed event on one or more social media platforms into actionable and/or useful information (e.g., feedback indications, as will be described). The system 300 includes an image capture device, such as the image capture device 110, a secondary device, such as the secondary device 120, a communications link between the image capture device 110 and the secondary device 120, such as the communications link 140, and one or more server computing devices, such as the one or more server computing devices (servers) 310-A and 310-B. While only two servers 310 are illustrated, it is understood that the image capture device 110 and/or the secondary device 120 may communicate with any suitable number of servers. In some implementations, the system 300 may omit the secondary device 120. For example, as described, the image capture device 110 may be configured to communicate directly with the one or more servers 310.

In some implementations, the servers 310 execute or host respective social media platforms. For example, as described, the server 310-A may host a first social media platform, and the server 310-B may host a second social media platform. The first social media platform may be different from the second social media platform. As described, the user may use the image capture device 110 to capture an event. The user may stream the event to the one or more social media platforms. For example, the user may use the image capture device 110 to capture video and audio of the user skiing down a hill. The user may communicate the captured video and audio to a respective one of the server 310-A and the server 310-B in order to live stream the captured event to the respective social media platforms. As described, viewers may view the streamed event, live or previously recorded, on the one or more social medial platforms and provide reactions and/or feedback to the user streaming the streamed event using interfaces associated with corresponding social media platforms. The user of the streamed event may adjust aspects of the captured event in response to the received reactions and/or feedback. For example, the user may change a perspective of the image capture device 110 in order to change a portion of the event being captured by the image capture device 110 in response to the reactions and/or feedback.

In some implementations, viewers of the streamed event may view the streamed event after the event has concluded (e.g., not live streaming). The viewers may provide reactions and/or feedback to the user of the streamed event after the event has concluded. The user may use the reactions and/or feedback provided after the live streamed event has concluded in order to adjust future live streamed events. The principles of the present disclosure apply to live streamed events, post-live streamed events, and/or other suitable streamed events.

In some implementations, the reactions and/or feedback provided by the viewers of the streamed event may include a plurality of feedback information items. The image capture device 110 (e.g., using the processor 222) is configured to generate one or more feedback indications or feedback metrics based on the plurality of feedback information items received from the one or more social media platforms. The image capture device 110 (e.g., using the processor 222) may assign or apply a score to each received feedback information items. A feedback information item may include a “thumbs up” icon, a “thumbs down” icon, a smiley face, a sad face, a neutral face, include positive feedback, negative feedback, neutral feedback, comments, other feedback, and/or a combination thereof. The image capture device 110 may use machine learning to determine whether a feedback information item corresponds to positive feedback, neutral feedback, negative feedback, a comment, or other suitable reaction and/or feedback. The image capture device 110 may apply a positive score (e.g., such as a positive number or a relatively large number) to positive feedback and a negative score (e.g., such as a negative number or a relatively small number) to negative feedback.

In some implementations, the image capture device 110 may apply a score to feedback information items that include comments. For example, the image capture device 110 may use natural language processing to identify comments having similar language and/or sentiments. For example, the image capture device 110 may use natural language processing to extract keywords from the comments associated with the feedback information items. The image capture device 110 may apply a similar score (e.g., the same number) to comments having the same or similar language and/or sentiment. While only limited examples are described herein, the image capture device 110 may apply scores in any suitable manner for any suitable feedback information item.

The image capture device 110 generates one or more feedback indications based on the scores assigned to each respective feedback information item. In some implementations, the image capture device 110 may generate a first feedback indication by summing the scores associated with positive feedback information items and a second feedback indication by summing the scores associated with negative feedback information items.

In some implementations, the image capture device 110 may generate a feedback indication by subtracting the sum of the scores associated with positive feedback information items from the sum of the scores associated with negative feedback information items. In some implementations, the image capture device 110 may identify scores associated with feedback information items that include comments. The image capture device 110 may identify a most frequently occurring comment associated with the feedback information items. For example, the image capture device 110 counts similar scores associated with feedback information items that include comments. The image capture device 110 may generate a feedback indication that includes the comment with the highest count (e.g., the comment that occurs most frequently). While only limited examples are described herein, the image capture device 110 may generate any suitable feedback indication using the scores associated with the feedback information items.

In some implementations, the image capture device 110 continuously updates the generated feedback indications and/or continuously generates new feedback indications. For example, as described, viewers may continue to provide feedback information items while viewing the streamed event on respective social media platforms. The image capture device 110 may continue to generate feedback indications based on the feedback information items. In some implementations, the image capture device 110 may update generated feedback indications based on the feedback information items.

In some implementations, the image capture device 110 may generate feedback indications that indicate a number or percentage of viewers having attention on the streamed event, a number or percentage of viewers viewing the event on a particular social media platform of the plurality of social media platforms the event is being streamed on, other suitable feedback indications, and/or a combination thereof.

In some implementations, the image capture device 110 may use machine learning to determine whether the viewers of the streamed event think the streamed event is engaging or boring based on the feedback information items. For example, the image capture device 110 may determine a percentage of viewers viewing the streamed event that provided a reaction or feedback while viewing the streamed event. The image capture device 110 may determine that the streamed event is engaging when the percentage is above a threshold. The image capture device 110 may use machine learning to determine other suitable aspects of the streamed event. In some implementations, the image capture device 110 may use aggregation and analysis of the feedback information items to generate feedback indications that summarize the feedback information items in a way that is actionable and/or useful to the user streaming the streamed event. While only the image capture device 110 is described as generating the feedback indications, the secondary device 120 and/or a remotely located computing devices may generate feedback indications instead of or in addition to the image capture device 110. In some implementations, both of the image capture device 400 and/or the secondary device 120 generate feedback indications. In some implementations, the remotely located computing device, such as a cloud computing device or other suitable computing device, may generate one or more feedback indications and communicate the feedback indications to the image capture device 110 and/or the secondary device 120.

The image capture device 110 (e.g., using the processor 222) may provide or communicate the one or more feedback indications to the user via the one or more feedback indicators associated with the image capture device 110, as described above. For example, the processor 222 may communicate generated feedback indications to the UI 212. The UI 212 may be configured to output at least one feedback indication. The UI 212 may include the one or more feedback indicators. The feedback indications provide a summary of the plurality of feedback information items provided by viewers of the streamed event. The summary can include a value indicating a number of viewers viewing the live stream of the of the event captured by the image capture device 100, a value indicating a quantity of positive feedback indicated by the feedback information items, or a value indicating a quantity of negative feedback indicated by the feedback information items. The user may use the feedback indications to understand how the viewers of the streamed event are reacting or perceiving the streamed event (e.g., understand the impact or meaning of the feedback information items) without having to sift through or view each of the plurality of feedback information items. The user streaming the event using the image capture device 110 may respond to the feedback indications, as will be described. For example, the user streaming the event may alter what is being captured in order to increase positive feedback. In some implementations, the image capture device 110 may be configured to automatically change focus of what is being captured by the image capture device 110 based on the feedback indications.

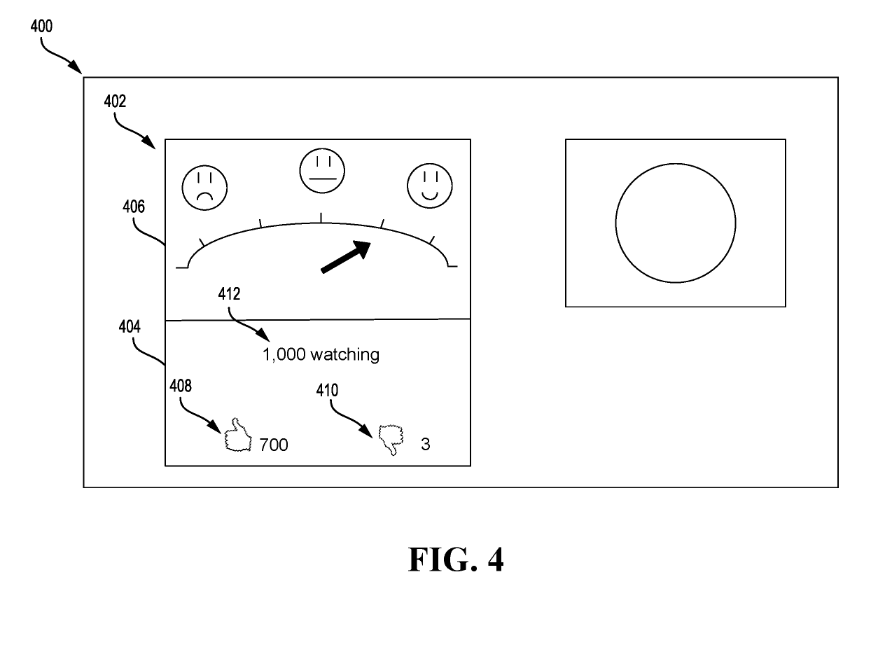

FIG. 4 generally illustrates an example image capture device 400 having a feedback display 402, according to the principles of the present disclosure. In some implementations, the image capture device 400 includes features similar to those described above with respect to the image capture device 110. The feedback display 402 includes features similar to those described above with respect to the UI 212.

The feedback display 402 is configured to display feedback indications generated by the image capture device 400, the secondary device 120, the remotely located computing device, and/or a combination thereof. While only the image capture device 110 and the image capture device 400 are described as generating the feedback indications, it is understood that a secondary device, such as the secondary device 120, and/or the remotely located computing device may generate feedback indications instead of, or in addition to, the image capture device 110 or the image capture device 400.

In some implementations, the feedback display 402 includes a first display portion 404 and a second display portion 406. The feedback display 402 may include additional or fewer display portions than those described herein. The first display portion 404 may be configured to display one or more feedback indicators that represent one or more respective feedback indications. For example, the feedback indicators may include one or more running totals, such as a positive feedback running total 408 and a negative feedback running total 410. The positive feedback running total 408 represents a feedback indication representing a total number of positive feedback information items. The negative feedback running total 410 represents a feedback indication representing a total number of negative feedback information items.

In some implementations, the first display portion 404 includes feedback indicators that represent statistical or metric information, such as a total number of viewers 412. The total number of viewers 412 represents a feedback indication that represents a number of viewers currently viewing the streamed event. The first display portion 404 may include additional or fewer feedback indicators than those described herein.

In some implementations, the second display portion 406 is configured to display one or more graphical feedback indicators that represent one or more respective feedback indications. For example, as is generally illustrated, the second display portion 406 may display a graphical representation of a difference between a feedback indication representing positive feedback information items and a feedback indication representing negative feedback information items (e.g., the graphical representation of the one or more feedback indications indicates whether the overall feedback received from viewers of the streamed event is more positive or more negative). For example, the graphical feedback indicators may include one or more emoji (e.g., as is generally illustrated), a chart (e.g., a pie graph, a bar graph, a histogram, or other suitable chart), other suitable graphical feedback indicators, and/or a combination thereof. In the example shown in FIG. 4, the second display portion 406 displays a graphical feedback indicator including a feedback scale. A “sad face,” a “neutral face,” and a “happy face” are displayed on the feedback scale. An arrow points to a location on the feedback scale (e.g. towards the “happy face”) to indicate that the overall feedback received from viewers of the streamed event is more positive than negative.

As described, the image capture device 400 continuously updates the feedback indications. The second display portion 406 may continuously update the graphical feedback indicators associated with the respective feedback indications. While only limited examples are described herein, the feedback display 402 may display any suitable feedback indications and/or any suitable graphical feedback indications other than those described herein.

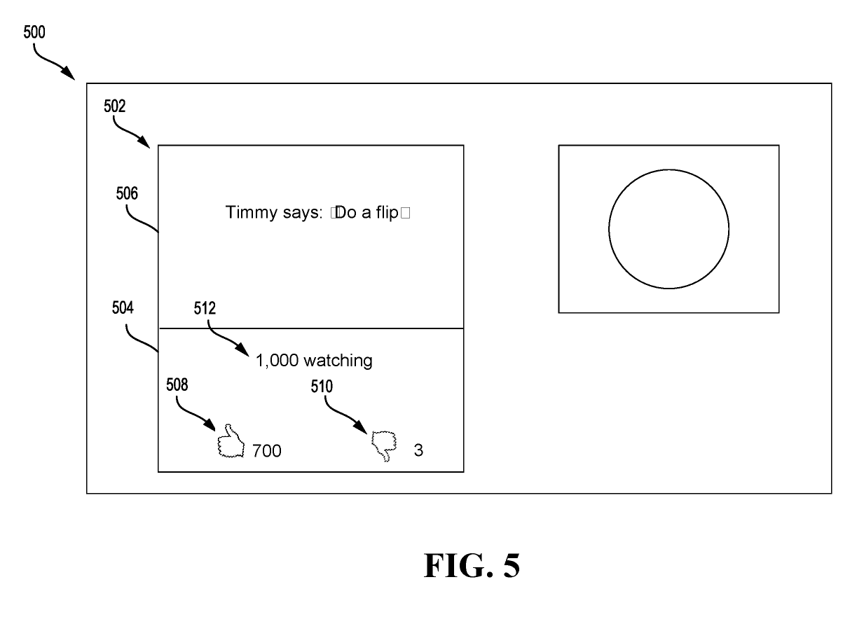

FIG. 5 generally illustrates an example image capture device 500 having a feedback display 502, according to the principles of the present disclosure. In some implementations, the image capture device 500 includes features similar to those described above with respect to the image capture device 110. The feedback display 502 includes features similar to those of the UI 212.

The feedback display 502 is adapted to display feedback indications generated by the image capture device 500, the secondary device 120, the remotely located computing device, and/or a combination thereof, as described. In some implementations, the feedback display 502 includes a first display portion 504 and a second display portion 506. The feedback display 502 may include additional or fewer display portions than those described herein. The first display portion 504 may be configured to display one or more feedback indicators that represent one or more respective feedback indications. For example, the feedback indicators may include one or more running totals, such as a positive feedback running total 508 and a negative feedback running total 510. The positive feedback running total 508 may include features similar to the positive feedback running total 408 and the negative feedback running total may include features similar to the negative feedback running total 410. In some implementations, the first display portion 504 includes feedback indicators that represent statistical or metric information, such as a total number of viewers 512 which may indicate a number of viewers currently viewing the streamed event. The total number of viewers 512 may include features similar to those of the total number of viewers 412. The first display portion 504 may include additional or fewer feedback indicators than those described herein.

In some implementations, the second display portion 506 is configured to display one or more comments associated with one or more respective feedback indications. For example, as is generally illustrated, the second display portion 506 may display a comment instructing the user streaming the event to take action (e.g., such as do a flip) while capturing the streamed event. The user may react to the comment by performing the action or may ignore the comment.

As described, the image capture device 500 may use machine learning and natural language processing in order to generate a feedback indication indicating a most frequently occurring comment. In some implementations, the feedback indication may indicate a comment that is “liked” by other viewers, or other suitable comments. The second display portion 506 may update the comment being displayed in response to receiving an updated feedback indication. The second display portion 506 may display information associated with the viewer providing the displayed comment. For example, the second display portion 506 may receive a feedback indication representing the comment and information associated with the viewer providing the comment. The second display portion 506 may be configured to display a user name and the comment represented by the feedback indication. In the example shown in FIG. 5, the second display portion 506 displays a comment “Do a flip” associated with a feedback indication to instruct the user to do a flip while capturing the streamed event. The display portion 506 also displays the identity (“Timmy”) of the user generating the comment. While only limited examples are described herein, the feedback display 502 may display any suitable feedback indications and/or any suitable comment other than those described herein.

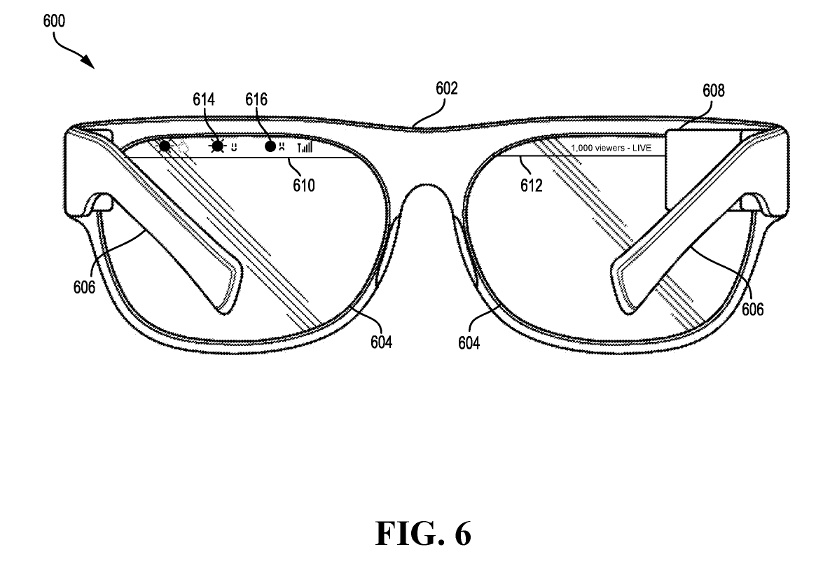

FIG. 6 generally illustrates an example image capture device 600, according to the principle of the present disclosure. In some implementations, the image capture device 600 includes features similar to those described above with respect to the image capture device 110. The image capture device 600 may include glasses, sunglasses, or other suitable form factors. The image capture device 600 may include a frame 602 shaped so as to perch on a face of the user of the wearable imaging device 600 when in a wearable position. The frame 602 may be formed of metal, plastic, composite, wood, and/or any other suitable wearable material. The frame 602 may be shaped to define openings that hold a pair of lenses 604. Each of the lenses 604 may be disposed within one of the openings on one side of the frame 602 and mounted so to as to be in a field of view of the user when the frame 602 is disposed on a face, for example, perched on the nose, of the user in the wearable position. The lenses 604 may be clear, shaded, partially shaded, opaque, reflective, and/or otherwise treated so as to allow selective, partial, and/or complete visibility through the lenses 604 by the user of the image capture device 600.

The image capture device 600 may include a pair of temple arms 606. Each of the temple arms 606 may be coupled to a respective side of the frame 602, for example, using hinges. The temple arms 606 can be coupled to the frame 602 using, for example, the hinges at first ends and include shaped pieces or portions suitable for hooking to ears of the user (or, for example, a shirt of the user) at second ends. The temple arms 606 may be formed of metal, plastic, composite, wood, and/or any other suitable wearable material. The frame 602 and the temple arms 606 may have a unitary construction, that is, the hinges or other adjustment mechanisms may not be present and the temple arms 606 may be fixed in position or flexible, but not necessarily foldable, in respect to the frame 602.

The image capture device 600 may include an electronics unit 608 mounted to and/or partially disposed within the frame 602. The electronics unit 608 may include any previously described component, including but not limited to the audio component 210, the user interface (UI) unit 212, the input/output (I/O) unit 214, the sensor controller 220, the one or more processors 222, the electronic storage unit 224, the image sensor 230, the metadata unit 232, the optics unit 234, the communication unit 240, the power system 250, and/or a combination thereof.

The image capture device 600 includes a first display portion 610 and a second display portion 612. The first display portion 610 and the second display portion 612 may include features similar to those of the UI 212. The first display portion 610 and the second display portion 612 may be included on the lenses 604 disposed within the frame 602. In some implementations, the first display portion 610 and the second display portion 612 are included on the same lens. In other implementations the first display portion 610 and the second display portion 612 are included on different lenses. The image capture device 600 may include additional or fewer display portions than those described herein. In some implementations, the first display portion 610 and the second display portion 612 may be disposed on a side of the image capture device 600 facing the user streaming the event captured by the image capture device 600. In some implementations, the first display portion 610 and the second display portion 612 may be disposed at or near a top portion of the image capture device 600 (e.g. near a top portion of the lenses 604 disposed within the frame 602) or other suitable location on the image capture device 600.

The first display portion 610 may be configured to display one or more feedback indicators that represent one or more respective feedback indications. For example, the feedback indicators may include, a positive feedback running total, a negative feedback running total, other suitable feedback indicators, and/or a combination thereof. The first display portion 610 may be configured to display other information, such as a network status indicator, a battery life indicator, other suitable information, and/or a combination thereof.

In some implementations, the second display portion 612 is configured to display one or more feedback indicators that represent statistical or metric information, such as a total number of viewers which may indicate a number of viewers currently viewing the streamed event. The second display portion 612 may include additional or fewer feedback indicators than those described herein.

In some implementations, the image capture device 600 includes lights such as light emitting diodes (LEDs) disposed on a side of the image capture device 600 that is visible to the user streaming the event captured by the image capture device 600 while the user is streaming the event. The image capture device 600 may illuminate one or more of the LEDs based on the generated feedback indications. For example, the image capture device 600 may include a first LED 614 and a second LED 616. The image capture device 600 may illuminate the first LED 614 when a difference between the feedback information items indicating positive feedback and the feedback information items indicating negative feedback is above a threshold (e.g., the overall feedback to the streamed event is more positive than negative).

Conversely, the image capture device 600 may illuminate the second LED 616 when the difference between the feedback information items indicating positive feedback and the feedback information items indicating negative feedback is below a threshold (e.g., the overall feedback to the streamed event is more negative than positive). While only a first LED 614 and a second LED 616 are described, the image capture device 600 may illuminate any suitable number of LEDs to indicate other suitable feedback indications than those described herein.

In some implementations, the image capture device 600 includes haptic feedback mechanisms that are selectively activatable by the image capture device 600. The haptic feedback mechanisms may be configured to vibrate, increase in temperature, provide other haptic feedback, and/or a combination thereof. The image capture device 600 may activate one or more of the haptic feedback mechanisms based on the generated feedback indications. For example, the image capture device 600 may include a first haptic feedback mechanism and a second haptic feedback mechanism. The image capture device 600 may activate a first haptic feedback mechanism when a difference between the feedback information items indicating positive feedback and the feedback information items indicating negative feedback is above a threshold (e.g., the overall feedback to the streamed event is more positive than negative). The user of the image capture device 600 may feel or sense the activation or the first haptic feedback mechanism, which may indicate to the user that the feedback to the streamed event is generally positive.

Conversely, the image capture device 600 may activate the second haptic feedback mechanism when the difference between the feedback information items indicating positive feedback and the feedback information items indicating negative feedback is below a threshold (e.g., the overall feedback to the streamed event is more negative than positive). The user of the image capture device 600 may feel or sense the activation or the second haptic feedback mechanism, which may indicate to the user that the feedback to the streamed event is generally negative.

In some implementations, the image capture device 600 may include a plurality of haptic feedback mechanisms. The image capture device 600 may activate a first haptic feedback mechanism to indicate that a feedback indication represents positive feedback. The image capture device 600 may activate a second haptic feedback mechanism to indicate that a feedback indication represents negative feedback. The image capture device 600 may activate a third haptic feedback mechanism to indicate that a feedback indication represents a comment received from a viewer of the streamed event. The user of the image capture device 600 may then utilize a display, such as the first display portion 610, to view the comment. The image capture device 600 may activate other suitable haptic feedback mechanisms to indicate other suitable information represented by feedback indications.

In some implementations, the image capture device 600 includes one or more audio outputs (e.g. speakers) configured to provide an audio indication based on the feedback indications. For example, an audio output may provide a first audio indication (e.g., an audio clip of a crowd cheering) when the feedback indications indicate that the feedback information items indicate positive feedback. The audio output may provide a second audio indication (e.g., an audio clip of a crowd booing) when the feedback indications indicate that the feedback information items indicate negative feedback. The audio outputs may provide any suitable audio feedback based on the feedback indications.

In some implementations, the image capture device 600 may communicate with wearable devices used by the user of the image capture device 600. A wearable device may include a wrist band, a watch, a ring, a wearable image capture device, or other suitable wearable device. The image capture device 600 may illuminate a light on the wearable device, activate a haptic feedback mechanism associated with the wearable device, interact with the wearable device in other suitable manners, and/or a combination thereof based on the feedback indications.

In some implementations, as described, the image capture device 110 may comprise a drone system 110-C. The user of the drone system 110-C may adjust a flight path, flight style, other suitable flight aspects of the drone system 110-C, and/or a combination thereof in response to the feedback indications. For example, the user of the drone system 110-C may receive feedback indications via feedback indicators on a controller associated with the drone system 110-C, on the secondary device 120, and/or a combination thereof. The user may adjust aspects and/or characteristics of the flight of the drone system 110-C based on the feedback indicators. In some implementations, the drone system 110-C may be configured to automatically adjust aspects and/or characteristics of the flight of the drone system 110-C based on the feedback indicators. For example, the drone system 110-C may change direction based on the feedback indicators, may roll based on the feedback indicators, or take other action based on the feedback indicators.

While examples are described for the various examples of the image capture device, any of the features described for any particular image capture device may be applied to any other image capture device. That is, any image capture device described herein may include some or all of the features described herein.

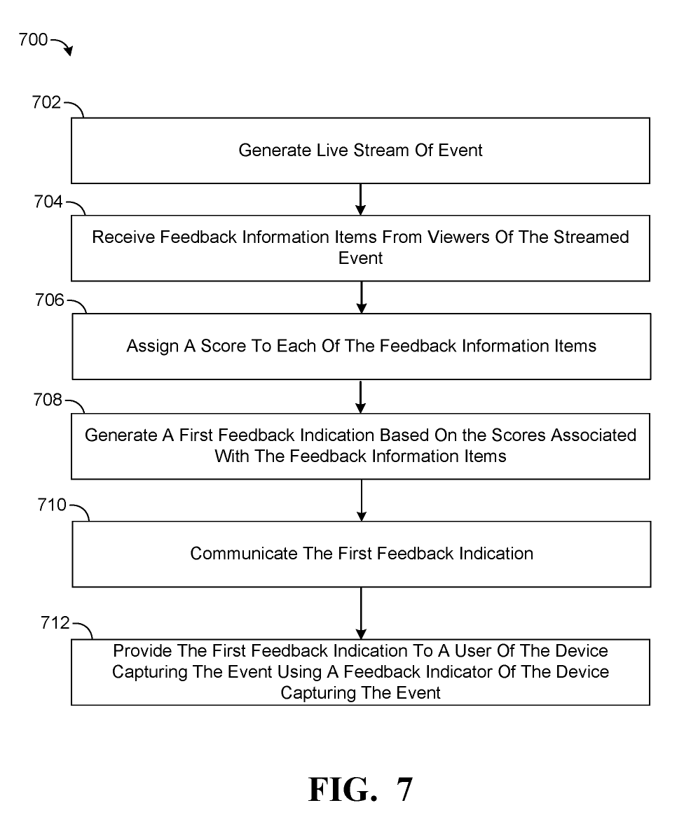

FIG. 7 is a flow chart generally illustrating an example set of operations for a method 700 for providing real-time streaming reaction feedback according to the principles of the present disclosure. At 702, the method 700 generates a live stream of an event. For example, as described, a user using an image capture device, such as the image capture device 110, captures an event. The user may stream the event to one or more social media platforms. At 704, the method 700 receives feedback information items from viewers of the streamed event. For example, as described above, viewers may view the streamed event on one or more of the social media platforms the streamed event is streamed on. At 706, the method 700 assigns a score to each of the feedback information items. For example, as described, the image capture device 110, the secondary device 120, the remotely located computing device, and/or a combination thereof, assigns a score to each of the feedback information items.

At 708, the method 700 generates a first feedback indication based on the scores associated with the feedback information items. For example, as described, the image capture device 110, the secondary device 120, the remotely located computing device, and/or a combination thereof generates a first feedback indication based on the scores associated with the feedback information items. At 710, the method 700 communicates the first feedback indication. For example, the image capture device 110, using the processor 222, communicates the first feedback indication to the UI 212. In some implementations, the secondary device 120 communicates the first feedback indication to the image capture device 110. In some implementations, the remotely located computing device communicates the first feedback indication to the image capture device 110, the secondary device 120, or both the image capture device 110 and the secondary device 120. At 712, the method 700 provides the first feedback indication to the user of the image capture device 110 using a feedback indicator associated with the image capture device 110. For example, as described above, the image capture device 110 uses one or more feedback indicators associated with the image capture device 110, a wearable device, the secondary device 120, and/or a combination thereof to provide the first feedback indication to the user using the image capture device 110 to stream the streamed event.

Where certain elements of these implementations may be partially or fully implemented using known components, those portions of such known components that are necessary for an understanding of the present disclosure have been described, and detailed descriptions of other portions of such known components have been omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote any type of interconnection or communication architecture that may be used to communicate data between two or more entities. The “bus” could be optical, wireless, infrared, and/or other suitable type of communication medium. The exact topology of the bus could be, for example, standard “bus,” hierarchical bus, network-on-chip, address-event-representation (AER) connection, or other type of communication topology used for accessing, for example, different memories in a system.

As used herein, the term “computer program” or “software” is meant to include any sequence of human or machine cognizable steps which perform a function. Such program may be rendered in virtually any programming language or environment including, for example, C/C++, C#, Fortran, COBOL, MATLAB™, PASCAL, Python, assembly language, markup languages, such as HTML, Standard Generalized Markup Language (SGML), XML, Voice Markup Language (VoxML), as well as object-oriented environments such as the Common Object Request Broker Architecture (CORBA), Java™ (including J2ME, Java Beans), and/or Binary Runtime Environment, such as Binary Runtime Environment for Wireless (BREW).

As used herein, the term “module” may refer to any discrete and/or integrated electronic circuit components that implement analog and/or digital circuits capable of producing the functions attributed to the modules herein. For example, modules may include analog circuits (e.g., amplification circuits, filtering circuits, analog/digital conversion circuits, and/or other signal conditioning circuits). The modules may include digital circuits (e.g., combinational or sequential logic circuits, memory circuits, and/or other suitable circuits.). The functions attributed to the modules herein may be embodied as one or more processors, hardware, firmware, software, or any combination thereof. Depiction of different features as modules is intended to highlight different functional aspects and does not necessarily imply that such modules must be realized by separate hardware or software components. Rather, functionality associated with one or more modules may be performed by separate hardware or software components, or integrated within common or separate hardware or software components.

As used herein, the terms “integrated circuit,” “chip,” and “IC” are meant to refer to an electronic circuit manufactured by the patterned diffusion of trace elements into the surface of a thin substrate of semiconductor material. By way of non-limiting example, integrated circuits may include field programmable gate arrays (FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data, including, without limitation, read-only memory (ROM), programmable ROM (PROM), electrically erasable PROM (EEPROM), dynamic random access memory (DRAM), Mobile DRAM, synchronous DRAM (SDRAM), Double Data Rate 2 (DDR/2) SDRAM, extended data out (EDO)/fast page mode (FPM), reduced latency DRAM (RLDRAM), static RAM (SRAM), “flash” memory, such as NAND/NOR, memristor memory, and pseudo SRAM (PSRAM).

As used herein, the terms “processor” and “digital processor” are meant generally to include digital processing devices. By way of non-limiting example, digital processing devices may include one or more of digital signal processors (DSPs), reduced instruction set computers (RISC), general-purpose complex instruction set computing (CISC) processors, microprocessors, gate arrays, such as field programmable gate arrays, PLDs, reconfigurable computer fabrics (RCFs), array processors, secure microprocessors, application-specific integrated circuits (ASICs), Visual Processing Units (VPUs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire, such as FW400, FW110, and/or other variations, USB, such as USB2, Ethernet, such as 10/100, 10/100/1000 (Gigabit Ethernet, 10-Gig-E, and/or other Ethernet implementations), MoCA, Coaxsys, such as TVnet™, radio frequency tuner, such as in-band or out-of-band, cable modem, and/or other radio frequency tuner protocol interfaces, Wi-Fi (802.11), WiMAX (802.16), personal area network (PAN), such as 802.15, cellular, such as 3G, LTE/LTE-A/TD-LTE, GSM, and/or other cellular technology, IrDA families, and/or other network interfaces.

As used herein, the term “Wi-Fi” includes one or more of IEEE-Std. 802.11, variants of IEEE-Std. 802.11, standards related to IEEE-Std. 802.11, such as 802.11 a/b/g/n/s/v, and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), High Speed Downlink Packet Access/High Speed Uplink Packet Access (HSDPA/HSUPA), Time Division Multiple Access (TDMA), Code Division Multiple Access (CDMA)(such as IS-95A, Wideband CDMA (WCDMA), and/or other wireless technology), Frequency Hopping Spread Spectrum (FHSS), Direct Sequence Spread Spectrum (DSSS), Global System for Mobile communications (GSM), PAN/802.15, WiMAX (802.16), 802.20, narrowband/Frequency Division Multiple Access (FDMA), Orthogonal Frequency Division Multiplex (OFDM), Personal Communication Service (PCS)/Digital Cellular System (DCS), LTE/LTE-Advanced (LTE-A)/Time Division LTE (TD-LTE), analog cellular, cellular Digital Packet Data (CDPD), satellite systems, millimeter wave or microwave systems, acoustic, infrared (i.e., IrDA), and/or other wireless interfaces.

As used herein, the terms “camera,” or variations thereof, and “image capture device,” or variations thereof, may be used to refer to any image capture device or sensor configured to capture, record, and/or convey still and/or video imagery which may be sensitive to visible parts of the electromagnetic spectrum, invisible parts of the electromagnetic spectrum, such as infrared, ultraviolet, and/or other energy, such as pressure waves.

While certain aspects of the technology are described in terms of a specific sequence of steps of a method, these descriptions are illustrative of the broader methods of the disclosure and may be modified by the particular application. Certain steps may be rendered unnecessary or optional under certain circumstances. In some implementations, certain steps or functionality may be added to the disclosed implementations, or the order of performance of two or more steps may be permuted. All such variations are considered to be encompassed within the disclosure.

What is claimed is:

1. A method for providing a feedback indication during a live stream of an event, the method comprising:
receiving the live stream of the event from a device capturing the event;
receiving feedback information items from viewers of the event during the live stream of the event;
assigning a score to each feedback information item;
generating a feedback indication based on the scores assigned to each feedback information item; and
providing the feedback indication to a user of the device capturing the event using a feedback indicator.

2. The method of claim 1, wherein providing the feedback indication to the user comprises communicating the feedback indication to the device capturing the event.

3. The method of claim 1, wherein the feedback indicator includes a display screen.

4. The method of claim 3, wherein the feedback indication includes a summary of the feedback information items.

5. The method of claim 4, wherein the summary includes a value indicating a number of viewers viewing the live stream of the event.

6. The method of claim 4, wherein the summary includes a value indicating a quantity of positive feedback indicated by the feedback information items.

7. The method of claim 4, wherein the summary includes a value indicating a quantity of negative feedback indicated by the feedback information items.

8. The method of claim 4, wherein the summary includes a graphical representation of the feedback information items.

9. The method of claim 1, wherein the feedback indicator includes a haptic feedback mechanism.

10. The method of claim 1, wherein the feedback indicator includes one or more light emitting diodes.

11. The method of claim 10, further comprising:
using the feedback indicator to provide the feedback indication to the user of the device capturing the event by selectively illuminating the one or more light emitting diodes based on the feedback indication.

12. The method of claim 1, further comprising:
receiving updated feedback information items from the viewers of the live stream of the event and generating an additional feedback indication based on the updated feedback information items.

13. The method of claim 12, further comprising:
communicating the additional feedback indication to the device capturing the event and using the feedback indicator of the device capturing the event to provide the additional feedback indication to the user of the device capturing the event.

14. An image capture device, comprising:
an image sensor configured to capture visual information;
a communication unit configured to stream the visual information to a server hosting a social media platform and receive feedback information items related to the visual information from the social media platform;
a processor configured to apply a score to each of the feedback information items and generate a feedback indication based on the score associated with each of the feedback information items; and
a user interface configured to output the feedback indication to a user of the image capture device.

15. The image capture device of claim 14, wherein the visual information includes an image or video.

16. The image capture device of claim 14, wherein the feedback information items include positive feedback information items and negative feedback information items.

17. The image capture device of claim 16, wherein the feedback indication includes a first feedback indication based on a sum of scores associated with the positive feedback information items and a second feedback indication based on a sum of scores associated with the negative feedback information items.

18. The image capture device of claim 16, wherein the feedback indication is based on a difference between a sum of scores associated with the positive feedback information items and a sum of scores associated with the negative feedback information items.

19. The image capture device of claim 16, wherein the user interface includes a display having a first display portion and a second display portion, and wherein the feedback indication includes:
a total number of the positive feedback information items and a total number of the negative feedback information items displayed on the first display portion; and
a graphical representation of a difference between a sum of scores associated with the positive feedback information items and a sum of scores associated with the negative feedback information items displayed on the second display portion.

20. A real-time streaming reaction feedback system, comprising:
an image capture device, including:
an image sensor configured to capture visual information; and
a communication unit configured to communicate the visual information; and
a secondary device, including:
a communication unit configured to receive the visual information, stream the visual information to a server hosting a social media platform, and receive feedback information items related to the visual information from the social media platform;
a processor configured to apply a score to each of the feedback information items and generate a feedback indication based on the score associated with each of the feedback information items; and
a user interface configured to output the feedback indication to a user of the image capture device.
